(19) United States
(12) Patent Application Publication
(10) Pub. No.: US 2023/0335772 A1
(43) Pub. Date: Oct. 19, 2023

(54) FUEL CELL ASSEMBLY AND METHOD FOR PRODUCING A FUEL CELL ASSEMBLY

(71) Applicant: Vitesco Technologies GmbH, Regensburg (DE)

(72) Inventors: Markus Ochs, München (DE); Stefan Granzow, München (DE)

(21) Appl. No.: 18/026,221

(22) PCT Filed: Sep. 24, 2021
(86) PCT No.: PCT/EP2021/076334

§ 371 Date: Mar. 14, 2023

(30) Foreign Application Priority Data
Sep. 25, 2020 (DE) 10 2020 212 103.6

(51) Int. Cl. H01M 8/248; H01M 8/241

(52) U.S. Cl. CPC H01M 8/248; H01M 8/241; H01M 2008/1095

(57) ABSTRACT

A fuel cell arrangement and a production method for a fuel cell stack which is stacked in a stacking direction and composed of a plurality of plate-shaped components stacked in a stacking direction, wherein the fuel cell has at least one end plate composed of a plurality of segments.

### CROSS REFERENCE TO RELATED APPLICATIONS

This application is the U.S. National Phase Application of PCT International Application No. PCT/EP2021/076334, filed Sep. 24, 2021, which claims priority to German Patent Application No. 10 2020 212 103.6, filed Sep. 25, 2020, the contents of such applications being incorporated by reference herein.

### FIELD OF THE INVENTION

The present invention relates to a multi-part fuel cell end plate.

### BACKGROUND OF THE INVENTION

End plates are attached to both ends of a fuel cell arrangement, or “stack”, in order to make the stack stable and to exert an adapted pressure on stacked fuel cells. The “stack”, or fuel cell stack, has fuel cells which are stacked in a stacking direction and each of which has a plate-shaped form and extends in a first transverse direction and a second transverse direction, orthogonal to the first, as viewed orthogonally in relation to the stacking direction.

Known fuel cell end plates can consist of multiple parts or sub-segments which, however, are fixed to form a common mechanical unit or plate. Mechanical forces are introduced into the plate, and thus into the stack and the fuel cells, via a clamping or tensioning device. In the process, mechanical clamping is used to press the entire end plate onto the stack, irrespective of the number of parts or segments comprising it.

In the stacking direction, fuel cells have a stack of the following:
an anode-side bipolar half-plate with a fuel channel structure for conducting a fuel,
an anode-side gas diffusion layer,
a membrane-electrode unit MEA, having an electrolyte membrane and electrode layers which are arranged on either side of said electrolyte membrane in the stacking direction and form an anode and a cathode for an electrochemical reaction of the fuel with an oxidizing agent,
a cathode-side gas diffusion layer,
a cathode-side bipolar half-plate with an oxidizing agent channel structure for conducting the oxidizing agent.

As regards the prior art for fuel cell stacks of this type, reference is made by way of example to the publications EP 2 357 698 B1, EP 2 445 045 B1, EP 2 584 635 B1, EP 2 946 431 B1 and EP 3 316 377 A1, each of which are incorporated herein by reference.

Fuel cell stacks are typically mechanically clamped by means of clamping bolts or screws and spring elements. In addition, there are solutions which guide a (usually metallic) band around the stack, the band then being secured to securing points on the end plates of the stack and pretensioned; in this respect, see e.g. US 2006/093890 (Steinbroner), incorporated by herein reference. An additional solution is clamping means that are on the basis of toothed belts or V-belts and are based on multiple belts together with multiple clamping units.

In particular, the homogeneous distribution of force over the active cell region requires large holding or clamping forces. For that reason, the mechanical structures of the end plate are partly bulky. Since the sealing planes and the guide means of the individual cells likewise must be mechanically retained and pressed on, here there is also contact pressure that bears against the active surface area.

The high clamping force of the active surface area of a stack can lead to similarly high stresses prevailing on the mechanical guide means and force absorption means in the sealing region. The structure of the end plate and of the guide plane is accordingly complicated. In addition, the operation of clamping places a high stress on the abovementioned guide plane, for example stacking aids, sliding guide, etc., and also on the clamping process itself. Here, it is necessary to take into account the movement of the plates, of the MEA individual layers, and of the seals at the same time.

### SUMMARY OF THE INVENTION

An aspect of the invention is therefore based on avoiding the abovementioned problems.

A fuel cell arrangement according to an aspect of the invention has a fuel cell stack comprising a plurality of components stacked in a stacking direction and at least one end plate, wherein the at least one end plate has a plurality of segments.

The components arranged to form a stack preferably correspond to the fuel cells described above and have, for example, a substantially plate-shaped form. At least at one end, preferably at two opposite ends in the stacking direction, the stack terminates in a respective end plate. In this respect, in principle, the end plate itself can form part of a fuel cell stack, or else directly or indirectly adjoin a fuel cell stack, be arranged next to a fuel cell stack, or rest on a fuel cell stack. In this context and within the scope of this application, the word “terminate” should be interpreted broadly and include the variants mentioned. According to an aspect of the invention, in this respect, at least one end plate has a plurality of segments, which are preferably separate parts. The at least one end plate thus preferably has a multi-part form, the separate parts not being fixedly connected to one another.

According to a preferred embodiment of the invention, the at least one end plate has a laterally segmented form. This means that the end plate consists of multiple non-cohesive parts arranged orthogonally to the stacking direction, for example next to one another or in one another. These parts are intended to make it possible for force to be introduced separately into various regions of the stack, for example into an active cell region and a sealing region, and other segments of the cells when the stack is being clamped. This can be realized in particular by plates that lie in one another and are not or are only partially in mechanical contact.

For the one part, this solution means that the clamping force is adapted optimally to the different requirements in the active region, in the sealing region and, if appropriate, other mechanically clamped regions. Each individual segment of the end plate can be clamped with the forces intended for it, in order that the design outlay for the development of the cell geometry can be reduced and also that the mechanical stresses on, for example, the seal itself can be optimized.

For the other part, a segmented end plate enables a sequential clamping process. In this respect, each position or segment to be clamped can be pretensioned and clamped individually, depending on requirements. This also reduces the stress in the stacking process itself, because mechanical holding forces, sealing positions and the active surface area with electrical contact resistance can be effected in an optimum sequence.

A fuel cell arrangement makes it possible, by way of an electrochemical reaction, to convert the chemical reaction energy of a continuously supplied fuel (e.g. hydrogen) and a continuously supplied oxidizing agent (e.g. oxygen or air) into electrical energy.

During operation of the fuel cells arranged in an electrical series connection by way of the (electrically conductive) bipolar half-plates, the reactants participating in the electrochemical reaction, that is to say the fuel (e.g. hydrogen) and the oxidizing agent (e.g. air), must be supplied on different sides of the membrane-electrode unit inside each fuel cell as viewed in the stacking direction.

To that end, the bipolar half-plates of each fuel cell are often formed with a channel structure on their sides facing toward the membrane-electrode unit, in order to introduce the fuel and the oxidizing agent through these channel structures into the adjacent respective gas diffusion layer on the respective sides of the membrane-electrode unit, and thus to guide them up to the respective electrode layer on the corresponding side of the electrolyte membrane via the respective gas diffusion layer.

The electrode layers are usually made from a carbon material and coated or permeated with a suitable catalyst. In this respect, the fuel-side electrode layer forms an anode and the oxidizing agent-side electrode layer forms a cathode of the membrane-electrode unit.

The product of the electrochemical reaction proceeding in the individual fuel cells, for example water, can be discharged via the fuel cell region that conducts the oxidizing agent (e.g. air).

In the individual fuel cells, the fuel-conducting region, i.e. anode-side channel structure, gas diffusion layer and electrode layer (anode), and the oxidizing agent-conducting region, i.e. cathode-side channel structure, gas diffusion layer and electrode layer (cathode), must be sealed off with respect to one another in order to prevent the exchange of gas between these regions, which is detrimental to the power efficiency.

This implies in particular that at least one of the two regions must be sealed off with respect to the surrounding area of the fuel cell or of the fuel cell stack (e.g. atmosphere), in order to prevent such exchange via the surrounding area. In practice, in this respect at least the fuel-conducting region is sealed off with respect to the surrounding area, in order to prevent loss of fuel from this fuel cell region into the surrounding area and the entry of a medium (e.g. air) into this fuel cell region from the surrounding area.

In particular for the purpose of forming an air-cooled fuel cell arrangement, the oxidizing agent-conducting region can also be configured as “open” toward the surrounding area. For example, the oxidizing agent channel structure provided in the individual fuel cells can be open on two sides of the fuel cell that are opposite one another, as viewed in a transverse direction, in order to enable a flow of the oxidizing agent (e.g. air) through the fuel cell arrangement in this transverse direction during operation. To that end, the oxidizing agent can be driven through the laterally open fuel cell arrangement, e.g. using a fan, and in the process ensure cooling at the same time.

In many cases, however, it is more advantageous when both the fuel-conducting region and the oxidizing agent-conducting region of the fuel cell stack are sealed off with respect to one another and the surrounding area.

For such sealing, what is conventional are, for example, separately manufactured seals inserted between the bipolar plate and the membrane-electrode unit, or, for example, dispensing/spraying sealing material on respective components of the fuel cells (e.g. bipolar plate, membrane-electrode unit) during an installation process, or prefabrication of components of the fuel cells with seals already molded thereon.

An active region that can be mentioned is in particular the region distinctly formed orthogonally to the stacking direction, in which the electrochemical reaction between the fuel and the oxidizing agent takes place. Usually, the active region of the individual fuel cells extends orthogonally to the stacking direction areally around the center of the plate-shaped components, whereas the sealing region encloses the active region. In the fuel cell stack, the sealing region thus, for example, encloses the active region of the stack in the manner of a jacket. It is also possible for a feed/discharge region or distribution region for fuel, oxidizing agent and, if appropriate, coolant to be enclosed or encompassed by the sealing region.

According to a preferred embodiment variant of the fuel cell arrangement according to the invention, at least one end plate of the stack comprises at least one first segment, which is assigned to a first functional region of the stack, or terminates said region in the stacking direction, and at least one second segment, which is assigned to a second functional region of the stack, or terminates said region in the stacking direction. Preferably, the first and the second segment can be clamped to the stack largely independently of one another. Thus, clamping over the at least one first segment causes a first force to be exerted on the first functional region of the fuel cell stack, and clamping over the at least one second segment causes a second force to be exerted on the second functional region of the fuel cell stack. The forces applied to the first and to the second functional region of the stack for compression purposes thus preferably can be set largely independently of one another. In particular, the first and the second force can be different from one another. The second segment then encloses the first segment, for example around the periphery.

Similarly, embodiments with more than two end plate segments for the selective introduction of force into more than two functional regions of the fuel cell stack are also possible and covered by the invention.

In this application, functional regions of the fuel cell stack that can be indicated are, for example, the regions described above: active region, sealing region, feed/discharge region or distribution region for fuel, oxidizing agent and, if appropriate, coolant.

To this end, the at least one end plate is preferably laterally segmented. However, in other embodiments it can also be horizontally and/or axially segmented.

In a preferred variant, the end plate is segmented such that multiple segments engage in one another during the clamping operation. This can be achieved, for example, by segmenting which is offset in stages.

For example, a variant in which the segments engage in one another such that clamping the active region of the stack over a first segment of the end plate also exerts a pretension on the second segment and thus the sealing region of the stack is advantageous. The sealing region can then subsequently, for example, be subjected to an even higher compressive force by way of further clamping over the second segment. Similarly, this is also conceivable in reverse, with a pretension being exerted on the first segment by clamping the second segment.

In some embodiments, the fuel cells of the fuel cell arrangement are designed as suitable for operation with hydrogen as fuel, e.g. with an electrolyte membrane in the form of a proton conducting membrane.

As an alternative, however, it is also possible to consider, for example, a design of the fuel cell arrangement for operation with another fuel, such as an organic compound (e.g. methane or methanol) or e.g. natural gas.

In one embodiment, the fuel cell arrangement is designed as suitable for operation with air as oxidizing agent.

In one embodiment, the bipolar half-plates are made from a metallic material. As an alternative, the bipolar half-plates may in particular be made e.g. from a carbon material or e.g. from an electrically conductive plastics material (e.g. correspondingly doped, e.g. with carbon black), or from another electrically conductive material.

According to one embodiment, the bipolar half-plates and end plates provided in the invention are respectively prefabricated separately and joined by stacking the individual components correspondingly to form a stack when the fuel cell arrangement is being produced.

According to a further aspect, the invention relates to a method for producing a fuel cell arrangement.

### BRIEF DESCRIPTION OF THE DRAWINGS

An aspect of the invention is described in more detail below on the basis of exemplary embodiments with reference to the accompanying drawings, in which, in each case schematically:

FIG. 1 shows a two-part end plate, and

FIG. 2 shows a one-part end plate.

### DETAILED DESCRIPTION OF THE PREFERRED EMBODIMENTS

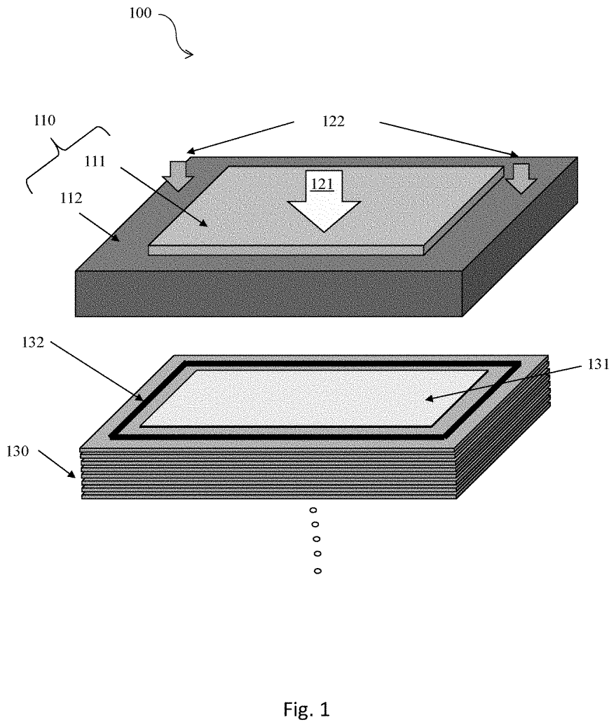

FIG. 1 shows a fuel cell 100 with an end plate 110 composed of two segments 111 and 112. Each fuel cell is composed of a plurality of components that have a plate-shaped form and are stacked in the stacking direction, with plate-shaped end plates at the respective ends of the stack. The end plate segments exert forces 121 and 122 on the cell stack 130. In particular, force 121 is exerted on an active region 131, and force 122 is exerted on a sealing region 132.

The end plates serve to make the stack stable and are therefore attached to the two ends in the stacking direction. However, more stability is required in the sealing region than in the active region. In general, the end plates are mechanically more stable than the bipolar plates in the middle of the stack. The homogeneous distribution of force over the active cell region requires large clamping forces 121. For that reason, the mechanical structures of the end plate are partly bulky.

The sealing planes and the guide means of the individual cells are likewise mechanically retained and pressed on. Here, there is also a contact pressure 122 that bears against the active surface area. Therefore, the outer segment 112 can exert more pressure on the sealing region than the inner segment 111 exerts on the active region, or vice versa, as required. The end plates may be realized in one another, with the segments being not or only partially in mechanical contact.

An end plate may consist of two segments, or more than two segments. Each individual segment of the end plate can be clamped with the forces intended for it, which makes it possible to reduce the design outlay for the development of the cell geometry. The mechanical stresses on elements such as the seal or sealing region can likewise be optimized.

Mechanical clamping is used to press the entire end plate onto the stack, irrespective of the number of parts or segments comprising it. The high clamping force of the active surface of a stack could lead to high stresses possibly prevailing on the mechanical guide means and force absorption means in the sealing region. The laterally segmented multi-part end plates make it possible for force to be introduced separately into, for example, the active cell region and the sealing region and other segments of the cells. Owing to the segmented end plate, a sequential clamping process is also possible.

In this respect, each segment to be clamped is individually clamped, or a clamping force is set. This can also reduce the stress in the stacking process, because mechanical holding forces, sealing positions and the active surface area with electrical contact resistance can be incorporated in the clamping in an optimum sequence.

In various embodiments of the invention, the segmenting is a lateral segmenting, axial or horizontal segmenting, or a combination of the two. It is also possible to have segments that are offset in stages, which engage in one another during the clamping operation. It is also possible to form a stack with a segmented end plate (for example, at the upper stack end) and a non-segmented end plate (for example, at the lower stack end).

The end plates can consist of the same material as the bipolar plates, or else can consist of another material. Fuel cell stacks are typically mechanically clamped by means of clamping bolts or screws, and possibly spring elements. In addition, there are solutions which guide a usually metallic band around the stack, the band then being secured to 1 or 2 securing points on the end plates of the stack and pretensioned.

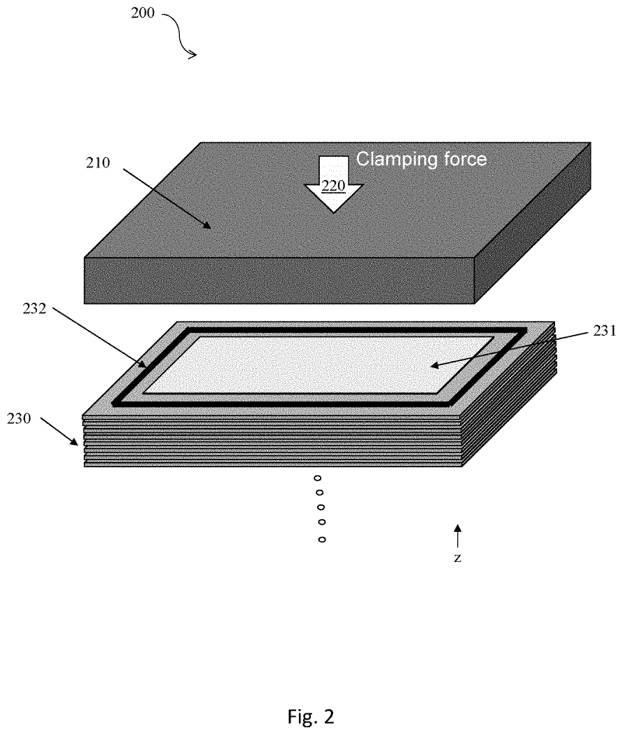

A one-part end plate is depicted in FIG. 2. FIG. 2 shows a fuel cell 200 with an end plate 210. Each fuel cell is composed of a plurality of components that have a plate-shaped form and are stacked in the stacking direction, with plate-shaped end plates at the respective ends of the stack. The end plate exerts force 220 on the cell stack 230, in particular on an active region 231 and on the sealing region 232.

The end plates must be configured for the pressure that is exerted. They may, for example, be formed from or consist of a steel or another metal. The end plates can also consist of an electrically non-conductive material, such as polymer compounds. However, the required mechanical properties must be ensured.

1. A fuel cell arrangement having a fuel cell stack comprising:
a plurality of plate-shaped components stacked in a stacking direction; and
at least one end plate,
wherein the at least one end plate has a plurality of segments.

2. The fuel cell arrangement as claimed in claim 1, wherein the plurality of segments of the at least one end plate are in the form of separate parts.

3. The fuel cell arrangement as claimed in claim 2, wherein the at least one end plate of the stack has at least one first segment, which is assigned to a first functional region of the stack, and at least one second segment, which is assigned to a second functional region of the stack, with the result that clamping over the at least one first segment causes a first force to be exerted on the first functional region of the fuel cell stack, and clamping over the at least one second segment causes a second force to be exerted on the second functional region of the fuel cell stack.

4. The fuel cell arrangement as claimed in claim 1, wherein the at least one end plate is laterally segmented.

5. The fuel cell arrangement as claimed in claim 1, wherein at least one end plate is axially or horizontally segmented.

6. The fuel cell arrangement as claimed in claim 1, wherein at least one end plate is designed with segments that are offset in stages.

7. The fuel cell arrangement as claimed in claim 1, wherein at least one end plate consists of segments which engage in one another during a clamping operation.

8. The fuel cell arrangement as claimed in claim 1, wherein one end plate is segmented and the other end plate is not segmented.

9. The fuel cell arrangement as claimed in claim 1, wherein at least one end plate consists of segments, and wherein the end plate consists of metal or of a material which is electrically non-conductive.

10. A method for producing a fuel cell arrangement as claimed in claim 1,
the method comprising:
forming a fuel cell arrangement by
stacking a fuel cell stack in a stacking direction, and
stacking end plates at either end of the stack in the stacking direction z,
wherein
at least one end plate has a plurality of segments.

11. The method for producing a fuel cell arrangement as claimed in claim 10, wherein each segment to be clamped is individually clamped.

12. The method for producing a fuel cell arrangement as claimed in claim 10, wherein segments to be clamped are subjected to different clamping forces.

13. The method for producing a fuel cell arrangement as claimed in claim 10, wherein the individual segments are subjected sequentially or simultaneously to the respective clamping force to be set.
